(19) United States
(12) Patent Application Publication
(10) Pub. No.: US 2026/0310618 A1
(43) Pub. Date: Oct. 8, 2026

(54) METHOD TO DETECT DATA COMMUNICATION LOCK-UP IN AN UART COMMUNICATION

(71) Applicant: Microchip Technology Inc., Chandler, AZ (US)

(72) Inventor: Avinash Halageri, Bangalore (IN)

(73) Assignee: Microchip Technology Inc., Chandler, AZ (US)

(21) Appl. No.: 19/194,147

(22) Filed: Apr. 30, 2025

(30) Foreign Application Priority Data
Apr. 2, 2025 (IN) 202511032766

(51) Int. Cl. G06F 13/36; H04L 12/40

(52) U.S. Cl. CPC G06F 13/36; H04L 12/40; G06F 2213/40

(57) ABSTRACT

A method comprises initiating a data transmission across a bus from a first universal asynchronous receiver/transmitter (UART) to a second UART, determining whether data is being transmitted via the bus, and aborting a data transmission via the bus when it is determined data is being lost from the data transmission. A microcontroller comprises a universal asynchronous receiver/transmitter (UART), a transmission register to include data to be transmitted by the UART, a bus in communication with the transmission register, and control logic to determine whether data is being transmitted via the bus and abort a data transmission via the bus when it is determined data is being lost from the data transmission.

### RELATED PATENT APPLICATION

This application claims priority to commonly owned Indian Patent Application No. 202511032766 filed Apr. 2, 2025, the entire contents of which are hereby incorporated by reference for all purposes.

### TECHNICAL FIELD

The present application relates to data communication systems, and more particularly, to detecting and handling communication lockups in Universal Asynchronous Receiver Transmitter (UART) interfaces.

### BACKGROUND

Data communication systems play a role in modern electronic devices, with Universal Asynchronous Receiver Transmitter (UART) interfaces being widely used for serial communication between components. UART communication involves transmitting data between a sender and receiver asynchronously, without using a shared clock signal. This makes UART interfaces versatile and suitable for various applications, from simple microcontroller projects to complex embedded systems.

In typical UART implementations, data is transferred through transmit and receive buffers, with status registers providing information about the communication process. The reliability and efficiency of UART communications may depend on proper management of these buffers and accurate monitoring of the communication status.

Data communication lockups in most scenarios typically end up with the watchdog reset as the ultimate bailout mechanism. Although the watchdog reset eventually provides the reset, it is a costly bail out mechanism for the application, because for a fault in the UART communication, the application in which the UART communication is running, is reset. To enable early bail out from these scenarios, two popular methods are available. One option is a software-based loop timeout mechanism and another is a hardware timer based timeout mechanism.

First, the software-based loop timeout mechanism typically involves a software variable that decremented along with a hardware status flag that is used to check for the status of data reception. While there is a check for the hardware status flag to be set, there is also a check if the loop timeout variable value is equal to “0”. Whichever exits the loop first, it means that the particular condition is satisfied. Problems with this method are Timeout value is dependent on system clock frequency, optimization levels. The data received bit setting is dependent on the number of bytes transferred, baud rate of data transferred. Methodology not portable, may be modified for changes of baud rate, system clock, optimization levels particularly for UART communication.

Second, a hardware timer-based timeout mechanism provides an early bailout. The issue is dependency on a hardware timer. If the timer runs too fast, the loop is exited early indicating a false negative. Typically, there may be one timer resource in the entire device. The one timer is used to maintain many soft timers in the application. It is difficult to synchronize the timer for just this early bailout purpose.

These options lead to methods that detect data communication lockup at an early instance. However, existing methods for detecting and handling communication lockups in UART interfaces may have limitations. These methods often rely on software-based loop timeouts or hardware timer-based approaches, which can be dependent on system clock frequencies, optimization levels, or specific hardware resources. Additionally, these approaches may not provide the earliest possible detection of communication issues, potentially leading to delays in error handling and system recovery.

There is a need for methods to detect data communication lockup in UART communications and abort the communication at the first sign of lockup.

### SUMMARY

According to aspects, there is provided a method comprising: initiating a data transmission across a bus from a first universal asynchronous receiver/transmitter (UART) to a second UART; determining whether data is being transmitted via the bus; and aborting a data transmission via the bus when it is determined data is being lost from the data transmission.

Aspects as in the previous paragraph provide a method, wherein initiating a data transmission comprises populating a UART transmit buffer of the first UART with data.

Aspects as in one of the previous two paragraphs provide a method, wherein determining whether data is being transmitted via the bus comprises receiving a UART start bit by the second UART.

Aspects as in one of the previous three paragraphs provide a method, comprising setting a UART status register with a transmit confirmation value when data is transmitted across the bus.

Aspects as in one of the previous four paragraphs provide a method, wherein determining whether data is being transmitted via the bus comprises checking the UART status register for the transmit confirmation value.

Aspects as in one of the previous five paragraphs provide a method, comprising issuing a data transmission signal when data is transmitted across the bus.

Aspects as in one of the previous six paragraphs provide a method, wherein determining whether data is being transmitted via the bus comprises determining whether a data transmission signal has been issued.

Aspects as in one of the previous two paragraphs provide a method, wherein aborting the data transmission when it is determined no data is being transmitted on the bus.

According to aspects, there is provided a microcontroller, comprising: a universal asynchronous receiver/transmitter (UART), a transmission register to include data to be transmitted by the UART; a bus in communication with the transmission register; and control logic to: determine whether data is being transmitted via the bus; and abort a data transmission via the bus when it is determined data is being lost from the data transmission.

Aspects as in the previous paragraph provide a microcontroller, comprising a UART status register to be set with a transmit confirmation value when data is transmitted across the bus.

Aspects as in one of the previous two paragraphs provide a microcontroller, wherein the control logic is to determine whether data is being transmitted via the bus by checking the UART status register for the transmit confirmation value.

Aspects as in one of the previous three paragraphs provide a microcontroller, wherein the control logic is to issue a data transmission signal when data is transmitted across the bus.

Aspects as in one of the previous four paragraphs provide a microcontroller, wherein the control logic is to determine whether data is being transmitted via the bus by determining whether a data transmission signal has been issued.

According to aspects, there is provided a system comprising: a first universal asynchronous receiver/transmitter (UART); a second UART; a bus connecting the first and second UARTs; and control logic to: determine whether data is being transmitted on the bus; and abort a data transmission via the bus when it is determined data is being lost from the data transmission.

Aspects as in the previous paragraph provide a system, wherein the first UART comprises a transmit buffer, and wherein the control logic is to populate data in the transmit buffer.

Aspects as in one of the previous two paragraphs provide a system, wherein the second UART comprises a receive buffer, and wherein the control logic is to populate data in the receive buffer.

Aspects as in one of the previous three paragraphs provide a system, wherein the control logic is to initiate a data transmission from the first UART to the second UART on the bus.

Aspects as in one of the previous four paragraphs provide a system, comprising a UART status register to be set with a transmit confirmation value when data is transmitted across the bus, wherein the control logic is to determine whether data is being transmitted via the bus by checking the UART status register for the transmit confirmation value.

Aspects as in one of the previous five paragraphs provide a system, wherein the control logic is to issue a data transmission signal when data is transmitted across the bus, wherein the control logic is to determine whether data is being transmitted via the bus by determining whether a data transmission signal has been issued.

Aspects as in one of the previous six paragraphs provide a system, wherein the control logic is to abort a data transmission when it is determined no data is being transmitted on the bus.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 is a block diagram of a UART system illustrating UART data communications.

FIG. 2 is an illustration of an example code for UART communication status monitoring.

FIG. 3A shows a flow diagram of UART data communications being conducted over time (t) without a safety mechanism being implemented.

FIG. 3B shows a flow diagram of UART data communications being conducted over time (t) with a safety mechanism being implemented.

FIG. 4 shows a flow chart of a method to detect data communication lockups in an UART at the earliest possible instance.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DESCRIPTION

According to aspects, there is provided a method to detect data communication lockups in an UART at the earliest possible instance. The method comprises: filling the data in a transmit buffer, starting the transmission, waiting for “2 bits transmission time,” and checking the RCIDL bit in the UxSTAT register (the UART Status Register). If the bit is set, it indicates that there is no activity on the communication line. Thereby it may be concluded that there is something wrong in either transmission or reception thereby exiting the communication. If the bit is not set, it may be concluded there is activity on the communication line, and the method may continue to wait for the data to be received. This can be repeated periodically until an entire set of bytes are transferred.

To simulate the data lockup mechanism, the transmission may be disabled (by disabling the Transmit Enable bit) and then filling the data in the transmit FIFO buffer. Once the FIFO buffer is full, the UART tries to send the data on the TX-RX communication bus. Since the Transmit enable bit is disabled, there will be no data that is sent on the TX-RX communication bus. This is indicated by the RCIDL bit, which is automatically set to high the hardware, indicating there is no data transfer that is happening. In software, the status of this RCIDL bit is checked and then the transmission is aborted. On the other hand, if the transmit enable bit is enabled, and then the data in the transmit FIFO buffer is filled, there is some data traffic on the TX-RX line, the RCIDL bit is set to 0, and the transmission is not aborted.

The Universal Asynchronous Receiver-Transmitter (UART) communication system may be used for serial data transmission between electronic devices. A UART communication system may include two primary components: a transmitter and a receiver. These components may be implemented in separate devices or may be integrated into a single device capable of both transmitting and receiving data. The transmitter in a UART system may be responsible for converting parallel data into serial format and sending it over a communication line. The transmitter may include any suitable components, such as a transmit buffer, a shift register, and control logic. The receiver in a UART system may be tasked with accepting incoming serial data, converting it back to parallel format, and making it available for the receiving device to process. The receiver may include any suitable components, such as a receive buffer, a shift register, and control logic.

UART communication may be characterized by its asynchronous nature, meaning that data transfer does not use a shared clock signal between the transmitter and receiver. Instead, the UART protocol may use start and stop bits to frame each data byte, allowing the receiver to synchronize with the incoming data stream.

The UART system may support various data formats, including different numbers of data bits, parity options, and stop bit configurations. These parameters may be configured to match the specifics of the application or devices involved in the communication. In some implementations, UART communication may utilize flow control mechanisms to manage the rate of data transfer between devices. This may help prevent data loss due to buffer overflow or other timing-related issues. UART systems may be susceptible to various types of communication errors or failures, including data corruption, timing misalignments, and communication lockups. Detecting and handling these issues may be crucial for maintaining reliable data transfer in UART-based applications.

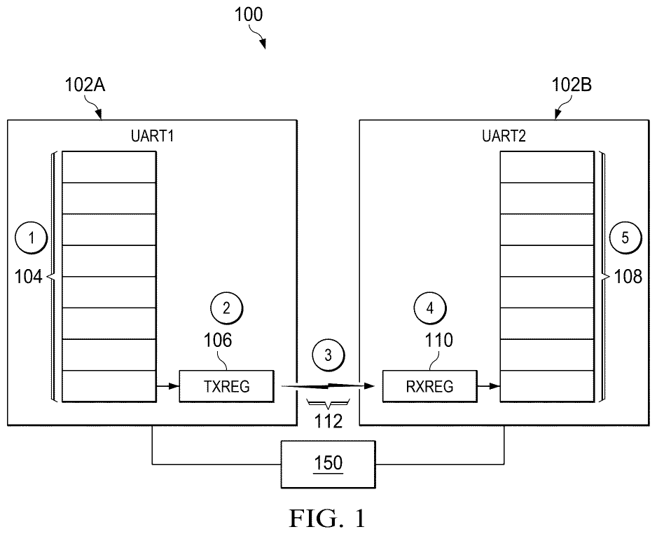

FIG. 1 is a block diagram of a UART system. The UART system 100 has two UART modules 102A and 102B and a communication line or bus 112 that connects the two UART modules 102A and 102B. UART modules 102A and 102B may include any suitable components for facilitating data transmission and reception, such as buffers, registers, and communication lines. A control logic 150 is to: determine whether data is being transmitted via the bus 112; and abort a data transmission via the bus 112 when it is determined data is being lost from the data transmission.

UART module 102A may include a transmit FIFO (First-In-First-Out) buffer 104, which may be used to store data awaiting transmission. The transmit FIFO buffer 104 may be capable of holding any suitable amount of data, such as 8 bytes. UART module 102A module may include a transmit register (TXREG) 106. In some implementations, data may be transferred in chunks from the transmit FIFO buffer 104 to the transmit register (TXREG) 106. The transmit register (TXREG) 106 may be responsible for converting parallel data into serial format for transmission over the communication line or bus 112. This conversion process may involve shifting out bits of data at a specified baud rate.

UART module 102B has receive FIFO buffer 108 and a receive register 110. The UART system 100 has a communication line or bus 112 that connects the transmit register (TXREG) 106 to the receive register (RXREG) 110. On the receiving end, the incoming serial data may first arrive at the receive register (RXREG) 110 of the receiving UART module 102B. The receive register (RXREG) 110 may be responsible for converting the incoming serial data back into parallel format. Finally, the received data may be transferred to the receive FIFO buffer 108 of the receiving UART module 102B. This receive FIFO buffer 108 may store the received data until the receiving device is ready to process it.

As shown in FIG. 1, the UART communication process may involve the transfer of data between UART modules 102A and 102B. According to Operation 1, data may be stored in the transmit FIFO (First-In-First-Out) buffer 104 to await transmission. According to Operation 2, data may be transferred in chunks from the transmit FIFO buffer 104 to the transmit register (TXREG) 106 and the transmit register (TXREG) 106 converts parallel data into serial format for transmission over the communication line or bus 112. According to Operation 3, the serialized data may be sent over the communication line or bus 112, which connects the transmitting UART module 102A to the receiving UART module 102B. According to Operation 4, the receive register (RXREG) 110 converts the incoming serial data back into parallel format and transmits the data in chunks to the receive FIFO buffer 108. According to Operation 5, the receive FIFO buffer 108 may store the received data until the receiving device is ready to process it.

The communication line or bus 112 may be susceptible to various issues that could potentially lead to communication lockups, such as noise interference or line disconnection. Throughout the UART communication process shown in FIG. 1, there may be several points where communication lockups, which are disruptions to data flow, could potentially occur. For example, the transmit FIFO buffer 104 may become full of data and cannot accept new data. As another example, the receive FIFO buffer 108 may not be emptied quickly enough so that it becomes full of data and cannot accept new data. Additional examples include issues on the communication line or bus 112 itself, such as noise or disconnection, which could lead to data loss or data transmission failures.

The UART communication process may involve careful timing and synchronization between the UART modules 102A and 102B to provide reliable data transfer. Monitoring the status of various components and the communication line or bus 112 may allow for detecting and addressing potential lockup situations.

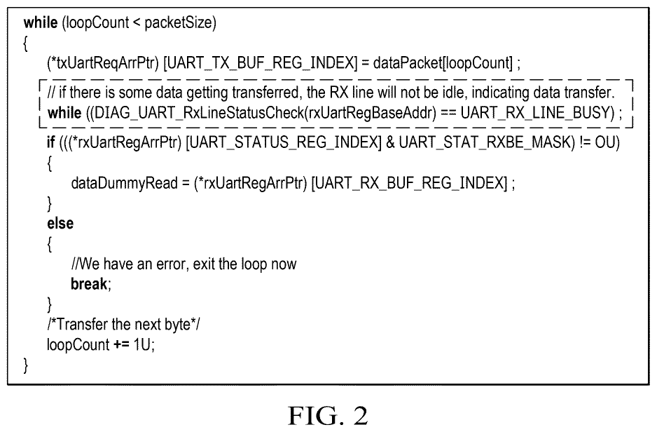

FIG. 2 is an illustration of an example code for UART communication status monitoring. The control logic 150 of FIG. 1 may implement this code of FIG. 2. The method for detecting communication lockups in UART interfaces may involve monitoring a Receive Idle (RCIDL) bit in a UART Status Register (UxSTAT). This approach may provide early detection of communication issues by checking the status of the communication line shortly after data transmission begins. The process may begin with filling the transmit FIFO buffer 104 with data and initiating the transmission. After starting the transmission, the method may involve waiting for a short period, such as a “2 bits transmission time”. This delay may allow sufficient time for the start of data transmission while still enabling early detection of potential issues. Following the delay, the RCIDL bit in the UxSTAT register may be checked. The RCIDL bit may indicate whether there is activity on the communication line or bus 112. If the RCIDL bit is set to “1”, it may indicate that there is no activity on the communication line or bus 112, suggesting a potential communication lockup or other issue. In the case where the RCIDL bit is set to “1”, indicating no activity, the method may involve breaking out of the communication loop and aborting the transmission. This early abort may prevent the system from waiting unnecessarily for a transmission that may not complete, potentially saving time and resources. Conversely, following the delay, the RCIDL bit in the UxSTAT register may be checked, and if the RCIDL bit is set to “0”, it may indicate that there is activity on the communication line. In this case, the method may continue to wait for data reception and proceed with normal communication processes.

The method may employ a status check circuit, which may include a software loop, to continuously check the RCIDL bit status while receiving data. This status check circuit may allow for ongoing monitoring of the communication line status throughout the data transfer process. The status check circuit may continue until all expected bytes are transferred or until an error condition is detected. Within the status check circuit, additional checks may be performed. For example, the method may involve checking if the receive buffer is empty. If the receive buffer is not empty, a dummy read operation may be performed to clear the buffer. If the receive buffer remains empty when it should contain data, this may be interpreted as an error condition, prompting the method to exit the loop and abort the communication.

By utilizing this method, potential communication lockups or issues may be detected at the earliest possible instance. This approach may offer advantages over traditional timeout-based methods, as it directly monitors the actual status of the communication line rather than relying on predetermined timeout values. The method may be particularly useful when transferring chunks of data, such as 8 bytes from the transmit FIFO buffer 104. It may provide a reliable way to monitor data traffic on the communication line or bus 112 and abort communication, without the dependencies associated with software or hardware timeout mechanisms.

The method for detecting communication lockups in UART interfaces may involve monitoring the Receive Idle (RCIDL) bit in the UART Status Register (UxSTAT). This approach may provide early detection of communication issues by checking the status of the communication line or bus 112 shortly after data transmission begins.

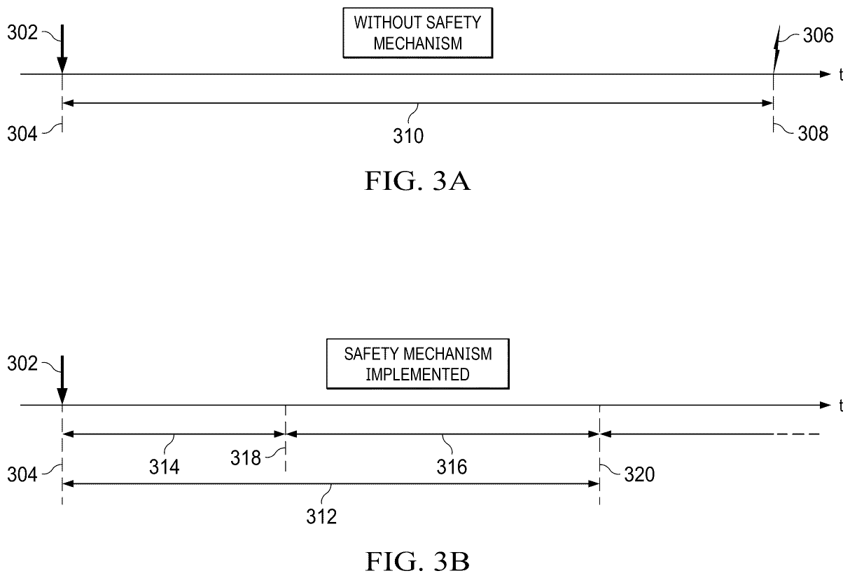

FIGS. 3A and 3B show flow diagrams of UART data communications in view of fault causing malfunctioning behavior without a safety mechanism and with a safety mechanism, respectively.

As shown in FIG. 3A, a UART data communication is being conducted over time (t) without a safety mechanism being implemented. A fault 302 causing malfunctioning behavior begins at a fault time instance 304. The malfunctioning behavior results in a hazardous event 306 at a hazard time instance 308. A fault tolerant time interval (FTTI) 310 is the minimum time-span from the occurrence of the fault 302 in an item to a possible occurrence of the hazardous event 306, if a safety mechanisms is not activated.

As shown in FIG. 3B, a UART data communication is being conducted over time (t) with a safety mechanism being implemented. For the safety mechanism to be effective, it should have a fault handing time interval (FHTI) 312 that is shorter than the FTTI 310. The FHTI 312 may equal a fault detection time interval (FDTI) 314 plus a fault reaction time interval (FRTI) 316. Assuming the system is able to fix the fault by the end of the FRTI 316, the system may thereafter transition to a safe state. A fault 302 causing malfunctioning behavior begins at a fault time instance 304. The system detects the fault 302 by a detection time instance 318. The system reacts to the fault 302 by a reaction time instance 320.

According to aspects, the method for detecting communication lockups in UART interfaces may involve monitoring a Receive Idle (RCIDL) bit in a UART Status Register (UxSTAT). The Receive Idle (RCIDL) bit is checked shortly after data transmission begins and within the fault detection time interval (FDTI) 314. If the RCIDL bit is set to “0”, it may indicate that there is activity on the communication line and the system assumes there is no fault. The Receive Idle (RCIDL) bit is again checked within the fault detection time interval (FDTI) 314 from the last check. If the RCIDL bit is still set to “0”, the system assumes there is still no fault. The system continues to monitor for faults by periodically checking the Receive Idle (RCIDL) bit in the UART Status Register (UxSTAT) within the fault detection time intervals (FDTIs) 314. The

If upon checking the UART Status Register (UxSTAT), the RCIDL bit is set to “1”, the system assumes a fault is detected. The system then aborts the transmission within the fault reaction time interval (FRTI) 316. By so doing, the system may have a fault handing time interval (FHTI) 312 that is shorter than the FTTI 310.

The Receive Idle (RCIDL) bit may also indicate data is being lost from the data transmission and may be interpreted as a fault. The Receive Idle (RCIDL) bit may also indicate no data is being transmitted on the bus and may be interpreted as a fault. A fault may be interpreted as a data communication lockup.

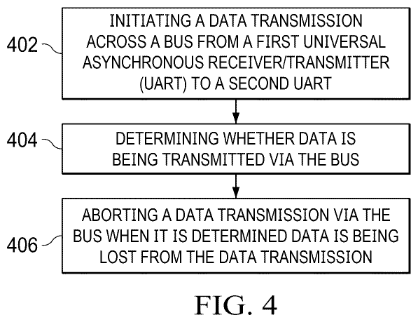

FIG. 4 shows a flow chart of a method to detect data communication lockups in an UART at the earliest possible instance. A data transmission is initiated 402 across a bus from a first universal asynchronous receiver/transmitter (UART) to a second UART. It is determined 404 whether data is being transmitted via the bus. A data transmission via the bus is aborted 406 when it is determined data is being lost from the data transmission.

The implementation of this method may not use additional hardware resources beyond those typically available in UART modules. This may make the method suitable for integration into existing UART-based systems without hardware modifications.

The method for detecting communication lockups in UART interfaces may have various applications and potential variations, particularly in safety-conscious systems such as automotive Electronic Control Units (ECUs). In automotive applications, the communication lockup detection method may be integrated into Functional Safety diagnostics for UART modules used in ECUs. ECUs may rely on reliable communication for vehicle functions so that early detection of communication issues maintains vehicle safety and performance. The method may identify and promptly address potential communication failures to reduce the risk of system malfunctions or safety hazards.

The implementation of this method in automotive ECUs may contribute to meeting stringent safety standards, such as ISO 26262 for functional safety in road vehicles. By providing a robust mechanism for detecting communication issues, the method may support the development of more reliable and fault-tolerant automotive systems.

Beyond automotive applications, the communication lockup detection method may be adapted for use in any suitable safety system that relies on UART communication. This may include industrial control systems, medical devices, or aerospace applications, where reliable data transfer provides for system operation and safety.

The method may be adapted or varied to suit different UART implementations or communication protocols. For example, the specific register or bit used for monitoring communication line activity may vary depending on the UART hardware implementation. In some cases, the method may be modified to work with different types of status flags or indicators available in various UART modules.

While the described method focuses on UART communication, similar principles may be applied to other serial communication protocols. The concept of monitoring communication line activity for early detection of lockups may be adapted for protocols such as SPI (Serial Peripheral Interface) or I2C (Inter-Integrated Circuit), with appropriate modifications to account for the specific characteristics and status indicators of each protocol.

The timing parameters used in the method, such as the ‘2 bits transmission time’ delay before checking the communication line status, may be adjusted based on the specifications of the application or the characteristics of the communication system. In some cases, this delay may be increased or decreased to optimize the balance between early detection and avoiding false positives. The method may also be extended to include additional diagnostic features. For example, it may be combined with error counting mechanisms to track the frequency of communication issues over time, potentially allowing for predictive maintenance or more sophisticated fault handling strategies.

Although examples have been described above, other variations and examples may be made from this disclosure without departing from the spirit and scope of these disclosed examples.

What is claimed is:

1. A method comprising:
initiating a data transmission across a bus from a first universal asynchronous receiver/transmitter (UART) to a second UART;
determining whether data is being transmitted via the bus; and
aborting a data transmission via the bus when it is determined data is being lost from the data transmission.

2. The method of claim 1, wherein initiating a data transmission comprises populating a UART transmit buffer of the first UART with data.

3. The method of claim 1, wherein determining whether data is being transmitted via the bus comprises receiving a UART start bit by the second UART.

4. The method of claim 1, comprising setting a UART status register with a transmit confirmation value when data is transmitted across the bus.

5. The method of claim 4, wherein determining whether data is being transmitted via the bus comprises checking the UART status register for the transmit confirmation value.

6. The method of claim 1, comprising issuing a data transmission signal when data is transmitted across the bus.

7. The method of claim 6, wherein determining whether data is being transmitted via the bus comprises determining whether a data transmission signal has been issued.

8. The method of claim 1, wherein aborting the data transmission when it is determined no data is being transmitted on the bus.

9. A microcontroller, comprising:
a universal asynchronous receiver/transmitter (UART),
a transmission register to include data to be transmitted by the UART;
a bus in communication with the transmission register; and
control logic to:
determine whether data is being transmitted via the bus; and
abort a data transmission via the bus when it is determined data is being lost from the data transmission.

10. The microcontroller of claim 9, comprising a UART status register to be set with a transmit confirmation value when data is transmitted across the bus.

11. The microcontroller of claim 10, wherein the control logic is to determine whether data is being transmitted via the bus by checking the UART status register for the transmit confirmation value.

12. The microcontroller of claim 9, wherein the control logic is to issue a data transmission signal when data is transmitted across the bus.

13. The microcontroller of claim 12, wherein the control logic is to determining whether data is being transmitted via the bus by determining whether a data transmission signal has been issued.

14. A system comprising:
a first universal asynchronous receiver/transmitter (UART);
a second UART;
a bus connecting the first and second UARTs; and
control logic to:
determine whether data is being transmitted on the bus; and
abort a data transmission via the bus when it is determined data is being lost from the data transmission.

15. The system of claim 14, wherein the first UART comprises a transmit buffer, and wherein the control logic is to populate data in the transmit buffer.

16. The system of claim 14, wherein the second UART comprises a receive buffer, and wherein the control logic is to populate data in the receive buffer.

17. The system of claim 14, wherein the control logic is to initiate a data transmission from the first UART to the second UART on the bus.

18. The system of claim 14, comprising a UART status register to be set with a transmit confirmation value when data is transmitted across the bus, wherein the control logic is to determine whether data is being transmitted via the bus by checking the UART status register for the transmit confirmation value.

19. The system of claim 14, wherein the control logic is to issue a data transmission signal when data is transmitted across the bus, wherein the control logic is to determine whether data is being transmitted via the bus by determining whether a data transmission signal has been issued.

20. The system of claim 14, wherein the control logic is to abort a data transmission when it is determined no data is being transmitted on the bus.
